(19) United States
(12) Patent Application Publication
(10) Pub. No.: US 2024/0082772 A1
(43) Pub. Date: Mar. 14, 2024

(54) VENT ASSEMBLY WITH MEDIA SUPPORT BRACE

(71) Applicant: Donaldson Company, Inc., Bloomington, MN (US)

(72) Inventors: Robert L. Dahlstrom, Cottage Grove, MN (US); Scott A. Betcher, Lakeville, MN (US); Michael S. Libbey, Edina, MN (US)

(21) Appl. No.: 18/367,406

(22) Filed: Sep. 12, 2023

Related U.S. Application Data
(60) Provisional application No. 63/406,087, filed on Sep. 13, 2022.

(51) Int. Cl. B01D 46/16; B01D 46/00; B01D 46/12; B01D 46/54; B01D 46/62

(52) U.S. Cl. CPC B01D 46/16; B01D 46/0031; B01D 46/12; B01D 46/543; B01D 46/62; B01D 2265/06; B01D 2279/35; F16H 57/027

(57) ABSTRACT

A vent assembly has a vent housing having a first axial end, a second axial end, and an airflow pathway extending from the first end towards the second end. An environmental opening is towards the second axial end for fluid communication with an external environment. An enclosure opening is towards the first axial end for fluid communication with an interior of an enclosure. A perimetric support surface surrounds the airflow pathway. A support brace extends across the airflow pathway. The support brace has a lateral support surface offset in the axial direction from at least a portion of the perimetric support surface. Filter media is disposed laterally across the airflow pathway. The filter media has a perimeter region supported by the perimetric support surface around the airflow pathway and a central region supported by the lateral support surface such that the filter media is non-planar.

This application claims priority to U.S. Provisional Patent Application Ser. No. 63/406,087, filed Sep. 13, 2022, the disclosure of which is incorporated herein by reference.

### TECHNOLOGICAL FIELD

The present disclosure is generally related to a vent assembly. More particularly, the present disclosure is related to a barrier vent assembly having a support brace.

### BACKGROUND

Various types of gearboxes, such as automotive transmissions, differential cases, and power transfer units, generally require some sort of breather vent that allows the pressure between the gearbox and the external environment to equalize. Some breather vents incorporate filter media to prevent the ingress of contaminants such as dust and fluids to the gearbox. For example, a microporous membrane can be used to prevent the entry of water in the gearbox. Oil particles that are present in the gearbox, however, can become airborne and lodge into the membrane. Oil coalescing filter media can be used to prevent the membrane from becoming clogged with oil. Coalesced oil can be returned from the filter media to the gearbox, preventing buildup.

### SUMMARY

Some embodiments of the technology disclosed herein relate to a vent assembly having a vent housing having a first axial end, a second axial end, and an airflow pathway extending from the first axial end towards the second axial end. The vent assembly has an environmental opening towards the second axial end configured for fluid communication with an external environment. An enclosure opening towards the first axial end is configured for fluid communication with an interior of an enclosure. The vent assembly has a perimetric support surface surrounding the airflow pathway. A support brace extends across the airflow pathway. The support brace has a lateral support surface offset in the axial direction from at least a portion of the perimetric support surface. The vent assembly also has filter media disposed laterally across the airflow pathway. The filter media has a perimeter region supported by the perimetric support surface around the airflow pathway. The filter media has a central region supported by the lateral support surface, such that the filter media is non-planar.

In some such embodiments, the lateral support surface is positioned axially between the perimetric support surface and the second axial end. Additionally or alternatively, the lateral support surface is positioned axially between the perimetric support surface and the first axial end. Additionally or alternatively, the lateral support surface is offset in the axial direction from the entire perimetric support surface.

Additionally or alternatively, the housing has an axial sidewall surrounding the airflow pathway, and the support brace has two ends that are each coupled to the axial sidewall. Additionally or alternatively, the filter media is a sheet of filter media. Additionally or alternatively, the sheet of filter media has a cross-dimension that is greater than the cross-dimension of the airflow pathway at the axial position of the sheet of filter media. Additionally or alternatively, the support brace is a cohesive component with the vent housing. Additionally or alternatively, the vent assembly includes a splash guard disposed across the airflow pathway, the splash guard being spaced in the axial direction from the support brace and the splash guard and the support brace defining a tortuous fluid pathway between the enclosure opening and the filter media.

Additionally or alternatively, the vent assembly further includes a membrane coupled to the vent housing between the filter media and the second axial end. Additionally or alternatively, the vent assembly further includes a spacing region between the filter media and the membrane. Additionally or alternatively, the filter media includes coalescing filter media. Additionally or alternatively, the filter media includes at least 10 sheets of filter media arranged in a stack in the axial direction.

Some embodiments disclosed herein relate to a method of making a vent assembly, including forming a vent housing having a first axial end and a second axial end, the vent housing defining an airflow pathway extending from the first axial end towards the second axial end. The vent housing has a perimetric support surface surrounding the airflow pathway. A support brace extends across the airflow pathway. The support brace has a lateral support surface offset in the axial direction from at least a portion of the perimetric support surface, and the vent housing has an environmental opening towards the second axial end. The method includes stacking a plurality of layers of filter media in the airflow pathway within the housing. The filter media has a perimeter region supported by the perimetric support surface around the airflow pathway. The filter media has a central region supported by the lateral support surface, such that the filter media is non-planar.

In some such embodiments, the lateral support surface is positioned axially between the perimetric support surface and the second axial end. Additionally or alternatively, the lateral support surface is positioned axially between the perimetric support surface and the first axial end. Additionally or alternatively, the lateral support surface is offset in the axial direction from the entire perimetric support surface. Additionally or alternatively, the housing has an axial sidewall surrounding the airflow pathway, and the support brace has two ends that are each coupled to the axial sidewall. Additionally or alternatively, the support brace is a cohesive component with the vent housing. Additionally or alternatively, the plurality of layers of filter media have a cross-dimension that is greater than the cross-dimension of the airflow pathway at the axial position of the sheet of filter media.

Additionally or alternatively, the vent assembly has a splash guard disposed across the airflow pathway. The splash guard is spaced in the axial direction from the support brace. The splash guard and the support brace define a tortuous fluid pathway between the environmental opening and the filter media.

Additionally or alternatively, the method includes coupling a membrane to the vent housing between the filter media and the second axial end. Additionally or alternatively, the method further includes inserting a media spacer between the filter media and the second axial end. Additionally or alternatively, the filter media includes coalescing filter media. Additionally or alternatively, the stack of the plurality of layers of the filter media includes at least 10 sheets of filter media arranged in a stack in the axial direction. Additionally or alternatively, the method includes coupling a cap to the vent housing.

### BRIEF DESCRIPTION OF THE DRAWINGS

FIG. 1 is a perspective view of a vent assembly consistent with the technology disclosed herein.

FIG. 2 is a cross-sectional view of a vent assembly consistent with the embodiment depicted in FIG. 1 in an example implementation.

FIG. 3 is a cross-sectional view of a vent assembly consistent with the technology disclosed herein.

FIG. 4 is a cross-sectional perspective view of a vent assembly consistent with the technology disclosed herein.

FIG. 5 is a cross-sectional view of a vent assembly consistent with the technology disclosed herein.

FIG. 6 is a diagram of a method consistent with the technology disclosed herein.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structures/components in a particular figure is, however, not to be interpreted as limiting the scope of the various embodiments in any way.

### DETAILED DESCRIPTION

### Description of Assemblies

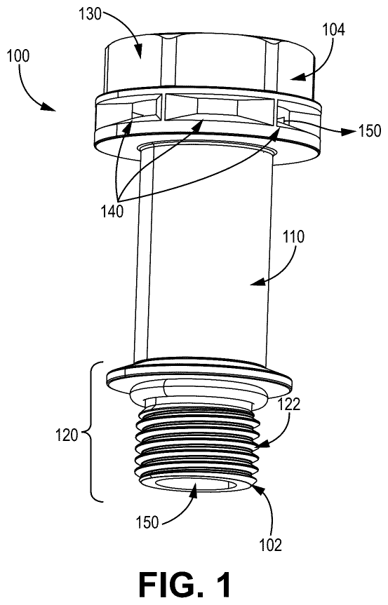

Vent assemblies consistent with the technology disclosed herein can have a variety of different configurations. FIG. 1 depicts a perspective view of a vent assembly consistent with the technology disclosed herein. The vent assembly 100 generally has a vent housing 110 defining a first axial end 102 and a second axial end 104. The first axial end 102 includes a mounting structure 120. The second axial end 104 defines one or more environmental openings 140. An airflow pathway 150 extends from the first axial end 102 to the second axial end 104. The airflow pathway 150 allows fluid communication between the mounting structure 120 and the environmental openings 140. Air may pass through the environmental openings 140 flowing to or from the environment external to the vent housing 110 (which will be referred to herein as the “external environment”). The vent housing 110 may be any suitable material including plastic or metal. In some embodiments, the vent housing 110 can be constructed of one or more materials including nylon, polyamide, glass-filled polyamide, polybutylene terephthalate, glass-filled polybutylene terephthalate, high-density polyethylene, and/or polypropylene, as examples.

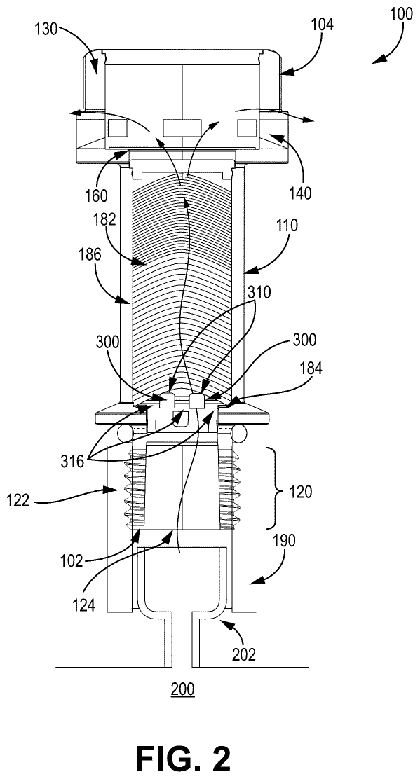

FIG. 2 depicts a cross-sectional view of the vent assembly 100 in an example implementation. The mounting structure 120 is configured to be in fluid communication with the interior of an enclosure 200. The enclosure 200 is generally configured to contain a hydrocarbon liquid such as oil. The enclosure 200 can also be configured to contain moving parts, such as gears. The enclosure 200 can be used for a variety of applications such as, for example, transmission systems, transfer cases, gear boxes, power transfer units, axle components, and the like. Such applications can particularly be found within industries such as automotive, manufacturing, energy production, and the like. Those having skill in the art will appreciate the wide applicability of the current technology to a variety of technological fields.

The enclosure opening 124 is defined by the mounting structure 120. The enclosure opening 124 is generally configured to allow fluids to pass between the enclosure 200 and the vent assembly 100. In embodiments where the enclosure 200 is subject to an increase in pressure relative to the external environment, the vent assembly 100 allows excess air to escape from the enclosure. The vent assembly 100 may advantageously equilibrate the pressure of the enclosure relative to the external environment. In the current example, the enclosure opening 124 is connected to the enclosure 200 using a connector tube 190.

The connector tube 190 is generally configured to attach the vent assembly 100 to the enclosure 200. In a variety of embodiments, the connector tube 190 is constructed of rubber. In embodiments, the connector tube 190 frictionally engages both the mounting structure 120 of the vent assembly 100 and the connecting portion 202 of the enclosure 200. In the current embodiment the mounting structure 120 defines a threaded coupling 122 that engages the connector tube 190. The connecting portion 202 and the connector tube 190 can engage with surface friction and/or with physical elements such as a reciprocal threaded coupling or other protuberance.

Other approaches can be used to couple the vent assembly 100 to the enclosure 200, as will be appreciated. The vent assembly 100 can be sealably coupled directly to the enclosure 200 through an approach such as with a snap fitting, with a bayonet connector, with one or more screws, and by welding, as examples. In many implementations, an O-ring is used to sealably couple the vent assembly 100 to the enclosure 200. The O-ring may be positioned between the mounting structure 120 and the connecting portion 202. In some embodiments the O-ring is positioned between the mounting structure 120 and the connector tube 190. In some embodiments, the O-ring contacts the mounting structure 120 to form an airtight seal. In some embodiments a mounting structure 120 of a vent assembly can be configured to directly receive an opening defined in an enclosure. In such embodiments, the O-ring can be configured to be compressibly and sealably disposed between the mounting structure 120 and the enclosure.

The vent assembly 100 is generally configured to prevent contaminants from passing from the second axial end 104 to the first axial end 102. In embodiments, the vent assembly 100 is generally configured to vent the enclosure 200 to which it is mounted while preventing the entry of dust, fluids, and other contaminants from the external environment to the enclosure 200. In some embodiments, the vent assembly 100 is designed to achieve IP69K ingress protection, meaning that, upon installation, the vent assembly 100 protects the enclosure 200 against close-range, high-pressure, high-temperature spray-downs. The vent assembly 100 is generally configured to coalesce oil droplets and drain the coalesced oil towards the first axial end 102 and through the enclosure opening 124. The vent assembly 100 is configured to drain the coalesced oil back into the enclosure 200.

The environmental openings 140 are generally configured to allow fluid communication between the interior of the vent housing 110 and the external environment. There may be any suitable number of environmental openings towards the second axial end 104. In some embodiments, there may be a single environmental opening 140. In the embodiment shown in FIG. 2, a plurality of environmental openings 140 are arranged perimetrically around the vent housing 110. The environmental openings 140 are positioned towards the second axial end 104 of the vent housing 110. When the environmental openings 140 are arranged perimetrically around the axial sidewall of the vent housing 110 may advantageously prevent environmental contaminants from entering the airflow pathway 150 and/or directly contacting the membrane.

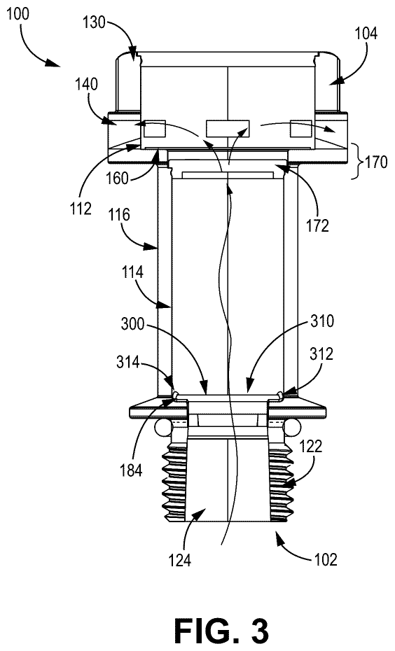

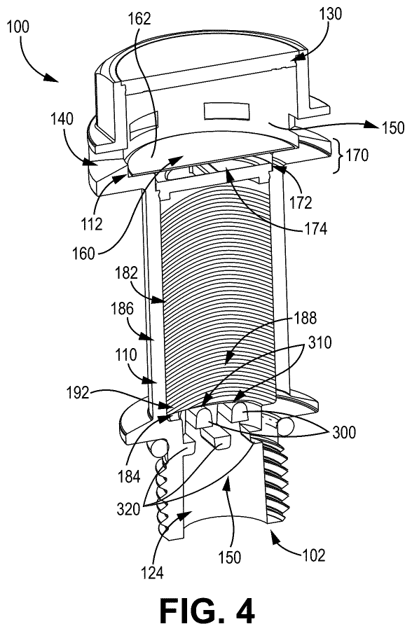

FIGS. 3-4 also depict cross-sectional views of an example vent assembly 100 consistent with FIGS. 1 and 2. FIG. 3 is a cross-section taken perpendicular to the cross-section depicted in FIG. 2. In FIG. 3, the filter media has been omitted for clarity of the features of the vent housing. FIG. 4 is a perspective cross-sectional view with the same cross-section of FIG. 2. The vent assembly 100 includes the vent housing 110, filter media 182, a perimetric support surface 184, and a support brace 300.

The vent housing 110 can include an axial sidewall 186 surrounding the airflow pathway 150. The axial sidewall 186 is generally configured to enclose at least a portion of the airflow pathway 150. The axial sidewall 186 generally extends in the axial direction. The axial sidewall 186 defines an inner perimeter 114 and an outer perimeter 116. The axial sidewall 186 may have any suitable wall thickness and axial length. In some embodiments, including that depicted, the axial sidewall 186 is elongate, meaning that it is longer than it is wide. In some other embodiments the axial sidewall is not elongate. In some embodiments, the axial sidewall 186 defines an annulus laterally surrounding the airflow pathway 150. The term “annulus” as used herein encompasses cross-sections having circular, ovular, polygonal, and irregular configurations. In some embodiments, the axial sidewall can have a plurality of axially extending segments joined at axially extending corners that cumulatively surround the airflow pathway 150 in the lateral direction.

The filter media 182 is disposed in the vent housing 110. The filter media 182 generally includes multiple sheets axially stacked within the vent housing 110. The filter media 182 is generally contained within the airflow pathway 150. In some embodiments, the filter media 182 is configured to coalesce and drain oil particles from the airflow pathway 150 to the enclosure 200 through the enclosure opening 124. Such a configuration prevents air-bound oil particles produced in the enclosure 200 from depositing on the membrane 160, which can result in pore blockages in the membrane 160, resulting in reduced vent life. The filter media 182 is described in more detail, below.

The perimetric support surface 184 is generally configured to support the perimeter region 192 of the filter media 182. The perimetric support surface 184 is generally positioned towards the first axial end 102 of the vent assembly 100. The perimetric support surface is generally positioned between the first axial end 102 of the vent assembly 100 and the filter media 182. The perimetric support surface 184 is generally configured to support the filter media 182 around the airflow pathway 150. In some embodiments, the vent assembly 100 is configured to be oriented with the first axial end 102 vertically below the second axial end 104, resulting in a gravitational force from the second axial end 104 to the first axial end 102. The perimetric support surface 184 is configured to prevent the filter media 182 from translating relative to the vent housing, such as in response to gravity. In some embodiments the entire perimeter region of the filter media is supported by the perimetric support surface 184. In some other embodiments, such as that depicted, a portion of the perimeter region 192 of the filter media is unsupported by the perimetric support surface 184. Such a portion of the perimeter region 192 of the filter media can be unsupported or can be supported by the support brace 300, which is now described.

A cross-sectional view of the support brace 300 is shown in FIG. 2. The lateral side of support brace 300 is shown in FIG. 3. The support brace 300 is generally configured to structurally support the filter media 182 to maintain a desired configuration of the filter media 182. The support brace 300 is generally disposed across the airflow pathway 150. However, the support brace 300 is generally configured to accommodate fluid flow along the airflow pathway 150. The support brace 300 includes gaps 316 in the lateral direction to accommodate fluid flow. Such gaps 316 define a portion of the axial length of the airflow pathway 150. The support brace 300 is generally positioned towards the first axial end 102 of the vent assembly 100.

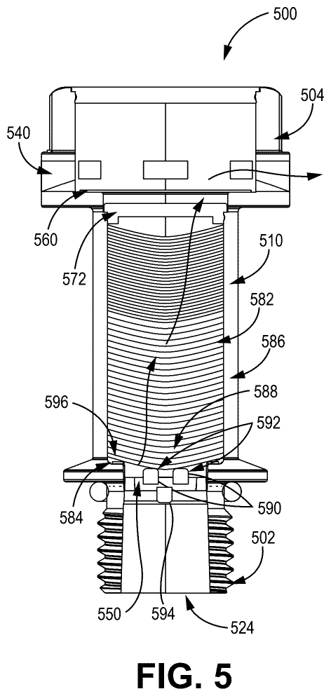

The support brace 300 has a lateral support surface 310. The lateral support surface 310 is generally configured to provide structural support to the filter media 182 across the airflow pathway 150. The lateral support surface 310 is generally offset in the axial direction from at least a portion of the perimetric support surface 184, which is best visible in FIGS. 2 and 3. The lateral support surface 310 generally faces the filter media 182. In other words, the lateral support surface 310 and the filter media 182 are axially aligned with the lateral support surface 310 of the support brace 300 oriented towards the filter media 182. In a variety of embodiments, the filter media 182 is in direct contact with the lateral support surface 310. In the examples shown, the lateral support surface 310 is completely offset from the perimetric support surface 184, meaning that the entirety of the lateral support surface 310 is in a different axial plane than any portion of the perimetric support surface 184. In some other embodiments, at least a portion of the lateral support surface 310 may be in the same axial plane as at least a portion of the perimetric support surface 184. In the current example, the lateral support surface 310 is positioned axially between the perimetric support surface 184 and the second axial end 104. In some other embodiments, the lateral support surface 310 is positioned axially between the perimetric support surface 184 and the first axial end 102, which will be described below with reference to FIG. 5.

The support brace 300 has a first end 312 and a second end 314 that are each coupled to the axial sidewall 186. Such a configuration is particularly visible in FIG. 3. While the ends 312, 315, of the support brace 300 are each coupled to the axial sidewall, the support brace 300 is typically not coupled to or in contact with the axial sidewall 186 at any other point. In other words, the lateral length of the support brace 300 between the first end 312 and the second end 314 is spaced from the axial sidewall 186. The space between the support brace 300 and the axial sidewall defines gaps 316 through which air can flow. Most of the lateral length of the support brace 300 is positioned within the inner perimeter of the vent housing. In this way, the support brace 300 extends laterally across the airflow pathway 150 without obstructing fluid communication along the airflow pathway 150. In embodiments, the support brace 300 is a cohesive component with the vent housing 110. The support brace 300 may be formed as a component of the vent housing 110 or it may be attached to the axial sidewall 186 of the vent housing 110 after each have been formed.

The support brace 300 may be formed from the same material as the vent housing 110, examples of which are listed above. Alternately, the support brace 300 may be formed from a different material than the vent housing 110. In various embodiments each of the vent housing 110 and the support brace are constructed of one or more materials that are selected to be resistant to degradation by the fluids of the enclosure (e.g., hydrocarbon fluids, organic solvents).

In the current example, the support brace 300 is depicted as including two linear bars extending in parallel laterally across the vent housing 110. However, the support brace 300 may include any suitable number of bars. In other embodiments, the support brace 300 may include only one bar, or more than two bars, as suitable. In embodiments where multiple bars are present, they may be parallel or non-parallel. In FIG. 4, the support brace is depicted as perpendicular to the axial direction, but it may be suitable for the support brace to be non-perpendicular and non-parallel to the axial direction. For example, a first end 312 of the support brace 300 may contact the axial sidewall 186 of the vent housing 110 a first axial distance from the enclosure opening 124, extend laterally across the airflow pathway 150, and the second end 314 of the support brace may contact the axial sidewall 186 a second distance from the enclosure opening 124, with the second distance being greater than the first distance. Other configurations are certainly possible.

The support brace 300 may have any suitable lateral cross-sectional shape (in the cross-section perpendicular to the length of the bars) and size. The lateral support surface may be non-planar, such as rounded. A non-planar lateral support surface may advantageously reduce contact with the filter media compared to a planar support surface. This may advantageously increase the amount of media surface area available for fluid flow. In FIG. 2, each bar of the support brace 300 is depicted as having a cross-sectional shape resembling a rhombus with a rounded top, with the flat end of the rhombus oriented towards the first axial end 102. Other cross-sectional shapes may be suitable for each bar of the support brace 300, including a circle, rectangle, triangle, or other polygon.

The support brace 300 may extend entirely across the radial extent of the vent housing 110, as is shown in FIG. 2. Alternately, the support brace 300 may extend partially across the radial extent of the vent housing 110. In embodiments, the first end 312 of a bar of the support brace 300 contacts the axial sidewall 186, and the second end of the bar 314 is not attached to the axial sidewall 186 but is positioned within the airflow pathway 150. In some embodiments, the support brace 300 may include more than one bar, where two of the bars are axially aligned and are attached to opposite sides of the axial sidewall 186.

The lateral support surface 310 of the support brace 300 is generally configured to structurally support the filter media 182. The lateral support surface 310 of the support brace 300 is generally offset in the axial direction from the perimetric support surface 184. The bottom-most layer of filter media is configured to be in contact with both the perimetric support surface 184 and the lateral support surface 310. This contact typically “tents” the filter media, causing the surface of the filter media to be non-planar.

In some embodiments, the lateral support surface 310 is offset from the entire perimetric support surface 184. In some other embodiments, the lateral support surface 310 is axially offset from only a portion of the perimetric support surface 184. The lateral support surface 310 may be offset between the perimetric support surface 184 and the first axial end 102, or it may be offset between the perimetric support surface 184 and the second axial end 104. In embodiments wherein the lateral support surface 310 is offset between the perimetric support surface 184 and the first axial end 102, the filter media 182 may be convex relative to the first axial end 102. In embodiments wherein the lateral support surface 310 is offset between the perimetric support surface 184 and the second axial end 104, the filter media 182 may be concave relative to the first axial end 102. The convex or concave orientation of the filter media 182 may affect how fluid from the enclosure 202 is coalesced and returned to the enclosure 202.

The filter media 182 is generally configured to coalesce fluid. The filter media 182 is typically disposed laterally across the airflow pathway 150. The filter media 182 has a perimeter region 192 supported by the perimetric support surface 184 around the airflow pathway 150. The filter media 182 has a central region 188 supported by the lateral support surface 310. The axial position of the central region 188 is offset from the axial position of at least a portion of the perimeter region 192, resulting in a non-planar configuration of the filter media 182.

In some embodiments, the filter media 182 is coalescing filter media. The coalescing filter media is not a sorbent of oil. In multiple embodiments, the coalescing filter media is oleophobic in nature, which can prevent wicking of the oil against gravity towards the second axial end 104 by reducing capillary action. The coalescing filter media can have an oleophobicity of at least about 6.5 based on AATCC Specification 118-2013 and ISO 14419. In one embodiment the coalescing filter media has an oleophobicity of at least about 7, and more particularly has an oleophobicity of about 7.5.

The filter media 182 may include any suitable materials and combinations of materials. For example, the filter media 182 can include bi-component fibers. The bi-component fibers can be constructed of two different polyesters. In some embodiments, the coalescing filter media can have glass fibers. In at least one embodiment the glass fibers are microfibers. Generally, the coalescing filter media substantially lacks a binder material, where the term “binder material” is defined herein to exclude the fibers in the filter media 182, such as the bi-component fibers or other fibers. Details about the materials used for the coalescing filter media 182 will be described in more detail below.

Coalescing filter media 182 can be a stack of a plurality of layers of synthetic filter media. A substantial portion of the layers can be stacked such that each flow face of each layer of filter media is in direct contact with the flow faces of adjacent layers of filter media. The term “flow face” is used to mean each surface of the filter media that is configured to face the directions of airflow through the airflow pathway 150.

Each of the sheets of filter media 182 has opposing flow faces having a shape, such as a circle or oval. In some embodiments, the sheets of filter media 182 can have another shape, such a polygonal shape. In some embodiments, the filter media 182 has a cross-dimension, such as a diameter or a diagonal, that is greater than the cross-dimension of the airflow pathway 150 at the axial position of the sheet of filter media along the airflow pathway 150. Such a configuration may advantageously increase the total filter media surface area available within the airflow pathway 150 relative to a configuration wherein the filter media 182 has a cross-dimension that is equal to the cross-dimension of the corresponding position of the airflow pathway 150. In other words, in embodiments wherein the cross-dimension of the filter media 182 is larger than the cross-dimension of the airflow pathway 150, the filter media 182 is typically not perfectly flat, but is rather bent or tented. The total surface area of filter media 182 within the airflow pathway 150 may be greater when tented filter media 182 is used than when flat filter media 182 is used. An increase in the total filter media surface area may improve coalescence of fluids and/or fluid flow capacity.

As used herein, a “layer” of filter media refers to an arrangement having opposing flow faces extending laterally across the airflow pathway and a thickness defined between the flow faces. A “sheet” of filter media may refer to a single formed layer of filter media. Alternately, a sheet of filter media may be folded to result in two or more layers of filter media.

In embodiments, each layer of filter media may be formed as an individual sheet. For example, a suitably shaped sheet of filter media may be cut from a larger sheet of media to form each layer of filter media. Multiple individual sheets may then be stacked. Additionally or alternatively, the plurality of layers of filter media may be formed from a single sheet of folded filter media.

As used herein, a “stack” of filter media refers to multiple layers of filter media arranged axially. The multiple layers of filter media may have substantially the same lateral position and may be arranged on top of or below one another.

In a variety of embodiments, a substantial portion of the stacked layers of filter media 182 are substantially unbonded to adjacent layers of stacked filter media. A “substantial portion” is intended to mean at least 50%, at least 60% or at least 80% of the layers of filter media in the stack. The term “substantially unbonded” is used to mean that at least 90%, 95% or 97% of the surface area of the layer of filter media is unbonded. In some such embodiments, each layer of the stacked layers of filter media 182 is substantially unbonded to adjacent layers of filter media. In some other embodiments, however, at least a portion of the layers of stacked filter media 182 are bonded to adjacent layers of filter media. In one example embodiment, a portion of the layers of stacked filter media 182 are thermally bonded to adjacent layers of filter media.

Coalescing filter media consistent with the technology disclosed herein is generally a wet laid media. The wet laid media can be constructed consistently with, for example, U.S. Pat. No. 10,717,031, issued on Jul. 21, 2020, incorporated by reference herein. The wet laid media is formed in a sheet by wet laid processing, formed into disks, and then inserted in the vent housing 110 of the vent assembly 100. Typically, as described above, the wet laid media disks are stacked in a plurality of layers in the vent housing 110 allowing gravity-assisted drainage of coalesced oil. In a variety of embodiments, the filter media is synthetic filter media.

In some embodiments, at least a portion of the layers of filter media have a cross-dimension that is greater than the cross-dimension of the airflow pathway 150 at the corresponding axial position of the airflow pathway 150. This generally results in filter media with a flow-face area that is larger than the corresponding cross-sectional area of the airflow pathway 150. Such configurations can prevent air from flowing through the airflow pathway 150 without passing through at least a portion of the plurality of layers of filter media.

In a variety of embodiments, the stack of the plurality of layers of filter media 182 has the number of layers of filter media that is sufficient to achieve the target overall particle filtration efficiency of the vent assembly 100. In some embodiments, the stack of the plurality of layers of filter media 182 has at least 2,10, 25, 50, 60, or 70 layers of filter media. In one embodiment the vent assembly 100 has about 90 layers of filter media. Typically, the total depth of the layers of filter media 182 will be about 0.5 inches (12.7 mm) or more. In embodiments, the total depth of the layers of filter media 182 is about 1.8 inches (45.7 mm) depending on the overall particle filtration efficiency desired.

The stack of the plurality of layers of filter media 182 is generally additionally configured to provide particle filtration. In a variety of embodiments, the stack of filter media 182 has an elongate structure, meaning that the stack of filter media 182 is longer than it is wide. Such an elongate structure can improve particle filtration by increasing the overall particle filtration efficiency of the stack of filter media 182 relative to the individual layers of filter media 182. The stack of the plurality of layers of filter media 182 can have an overall particle filtration efficiency of at least 90%, at least 95%, and/or at least 99%, wherein “overall particle filtration efficiency” is used herein to define the particle filtration efficiency of the stack of the plurality of layers of filter media 182.

In a variety of embodiments, the stack of the plurality of layers of filter media 182 can additionally have at least one secondary layer of coalescing filter media. The at least one secondary layer of coalescing filter media can have a particle filtration efficiency that is different than the rest of the layers of coalescing filter media. In embodiments, it can be desirable to position the at least one secondary layer of filter media away from the enclosure 200 due to the risk of fouling the coalescing filter media upon contact with oil from the enclosure 200. In one embodiment the at least one secondary layer of coalescing filter media is consistent with media layers described in U.S. Pat. No. 10,717,031, issued on Jul. 21, 2020, which is incorporated herein by reference.

Returning to the embodiment depicted in FIG. 4, the filter media is disposed laterally across the airflow pathway 150. Each layer of filter media has a perimeter region 192 at the perimeter of the layer. The perimeter region 192 of the bottom-most layer of filter media is directly supported by the perimetric support surface 184. Each layer of filter media has a central region 188. The central region 188 of the bottom-most layer of filter media is directly supported by the lateral support surface 310 of the support brace 300. As described herein, the lateral support surface 310 of the support brace 300 is at least partially axially offset from the perimetric support surface 184. Therefore, the bottom-most layer of filter media, and by extension, each layer of filter media 182, is non-planar. In the embodiment shown in FIG. 4, the central region 188 of the filter media is positioned above the perimeter region 192, forming a concave shape relative to the first axial end 102 of the vent assembly 100.

In embodiments where the enclosure 200 contains liquid, the liquid may move and splash during operation, either due to changing fluid dynamics such as increased pressure, or spatial movement of the enclosure, such as during operation of a vehicle. It is generally desirable for any fluids within the enclosure to minimally contact the filter media 182. When the filter media 182 directly contacts fluid, such as oil or other liquids in the enclosure, it may decrease the lifespan and/or efficacy of the filter media.

As shown in FIG. 4, the housing can include a splash guard 320. The splash guard 320 is generally configured to obstruct splashing liquids in the enclosure 200 from contacting the interior of the vent housing. The splash guard 320 may be offset from the perimetric support surface 184 in the axial direction and the lateral direction. The splash guard 320 is offset in the axial direction from the support brace 300. The splash guard 320 may be offset between the support brace 300 and the first axial end 102. In some embodiments, the splash guard 320 and the support brace 300 cumulatively define a tortuous fluid pathway along the airflow pathway 150 between the enclosure opening 124 and the filter media 182. As used herein, a “tortuous fluid pathway” refers to a pathway in which there is no direct line of sight to the filter media 182 from the first axial end 102.

In FIG. 4, the splash guard 320 is depicted as a plurality of bars extending laterally across the vent housing 110. The splash guard bars are depicted as having a lateral cross-sectional shape (in the cross-section perpendicular to the length of the bars) resembling a rhombus with a tapered side, where the flat side of the rhombus is oriented towards the second axial end 104 of the vent assembly 100. The tapered side can be oriented to face the first axial end 102 of the vent assembly 100, which may advantageously coalesce liquid to form droplets that drain out through the enclosure opening 124 under the force of gravity. The splash guard 320 may have any suitable number of bars, each of which may have any suitable axial cross-sectional shape. Samples of suitable axial cross-sectional shapes include rectangles, circles, and polygons.

The splash guard 320 may include more than one bar. Alternately or additionally, the splash guard 320 may form a shape other than a bar extending laterally across the vent housing 110. In embodiments, the splash guard 320 may form a cross, a grate, or a grid. The splash guard 320 may have any suitable width and height to form a tortuous pathway between the enclosure 200 and the filter media 182. In embodiments, the vent assembly 100 may include more than one splash guard 320. In embodiments, the splash guard 320 may include multiple layers.

In the embodiment shown in FIG. 4, a vent cap 130 is coupled to the vent housing 110 and is generally configured to shield a flow face 162 of the membrane 160 from the environment. The environmental openings 140 defined by the vent housing 110 are generally defined to similarly shield the flow face 162 of the membrane 160 from the environment. “Shielding” the flow face of the membrane 160 is intended to mean that the relevant features of the vent assembly 100 are configured to prevent external environmental contaminants from directly impacting the flow face of the membrane 160.

In a variety of embodiments, including that depicted in FIG. 4, the vent assembly 100 has a spacing region 170 that is at least partially defined by a media spacer 172. The spacing region 170 is generally configured to prevent direct contact between liquid in the filter media 182 and the membrane 160. Such a configuration may advantageously prevent obstruction of the membrane 160 pores by the liquid. The media spacer 172 is disposed within the vent housing 110. Typically, the media spacer 172 is axially between the coalescing filter media 182 and the membrane 160. The media spacer 172 has spacer openings 174 that define a portion of the airflow pathway 150. As such, the spacer openings 174 accommodate fluid flow therethrough. In the current embodiment, the media spacer 172 is generally configured to prevent contact between the coalescing filter media 182 and the membrane 160.

The membrane 160 is generally configured to serve as a barrier to outside fluid and dust contamination for the enclosure 200 while allowing air exchange between the first end 102 and second end 104 of the vent assembly 100 along the airflow pathway 150. As such, the membrane 160 is generally disposed across the airflow pathway 150. In a variety of embodiments, the membrane 160 is coupled to a membrane receiving surface 112 defined by the vent housing 110, where the membrane receiving surface 112 is partially visible in FIG. 4. In one embodiment, the membrane 160 is pleated. Pleating the membrane 160 may increase airflow.

Various types of materials are suitable for use as the membrane 160. Generally, the membrane 160 is a microporous material, where the term “microporous” is intended to mean that the material defines pores having an average pore diameter between about 0.001 microns and about 5.0 microns. The membrane 160 generally has a solidity of less than about 50% and a porosity of greater than about 50%. In a number of embodiments, the membrane 160 has a plurality of nodes interconnected by fibrils. In a number of embodiments, the membrane 160 is an expanded polytetrafluoroethylene (PTFE) membrane. The membrane 160 can also be constructed of polyamide, polyethylene terephthalate, acrylic, polyethersulfone, and/or polyethylene, as other examples. The membrane 160 can have the following physical properties: water entry pressure (WEP) of at least 5 psi and a Frazier permeability of greater than 0.275 ft/min at 0.5 inches H2O (0.01807 psi).

In some embodiments the membrane 160 is a laminate. For example, the membrane 160 can be a Tetratex™ grade from Donaldson Company, Inc., based in Minneapolis, MN, which is laminated to a non-woven nylon support layer such as that available from Cerex Advances Fabrics, Inc. located in Cantonment, Florida. In such an example, the membrane has a WEP of about 9 psi and a Frazier permeability of about 1.8 ft/min at 0.5 inches H2O (0.01807 psi).

In a number of embodiments, the membrane 160 is oleophobic. The membrane 160 can have an oleophobic treatment. In one particular embodiment the membrane 160 has an oleophobicity rating of 6, 7 or 8 based on AATCC Specification 118-1992 and ISO 14419.

FIG. 5 shows an alternate embodiment of a vent assembly consistent with the technology disclosed herein. The vent assembly is consistent with the descriptions of vent assemblies discussed above with reference to FIGS. 1-4, except where contrary to the current description and/or figure. FIG. 5 shows a vent assembly 500 including a vent housing 510. The vent housing 510 has a first axial end 502 and a second axial end 504, and an airflow pathway 550 defined by an axial sidewall 586 extending from the first axial end 502 towards the second axial end 504. The second axial end 504 has environmental openings 540 configured for fluid communication with the external environment. The vent assembly 500 has an enclosure opening 524 towards the first axial end 502 configured for fluid communication with an interior of an enclosure. The vent assembly 500 has a perimetric support surface 584 surrounding the airflow pathway, and a support brace 590 extending across the airflow pathway. The support brace 590 has a lateral support surface 592. The vent assembly also includes filter media 582 disposed laterally across the airflow pathway, wherein the filter media 582 has a perimeter region 596 contacting the perimetric support surface around the airflow pathway. A central region 588 of the filter media 582 is in contact with the lateral support surface 592 of the support brace 590.

In the example shown in FIG. 5, the lateral support surface 592 of the support brace 590 is positioned between the perimetric support surface 584 and the first axial end 502. In this configuration, the lateral support surface 592 of the support brace 590 is in contact with the filter media 582. The filter media 582 is non-planar and forms a convex shape relative to the first end 502. The splash guard 594 is offset in the axial direction from the perimetric support surface 584 and is positioned between the first axial end 502 and the perimetric support surface 584.

The example shown in FIG. 5 includes a membrane 560 and a media spacer 572. The membrane 560 and media spacer 572 are consistent with those described herein.

### Description of Methods

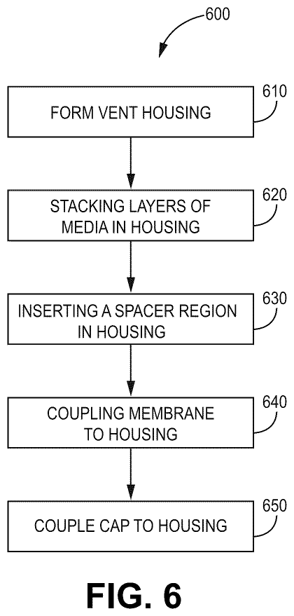

FIG. 6 is a flow chart depicting one method consistent with the technology disclosed herein. The method 600 is generally consistent with making a vent assembly that is consistent with vent assembly embodiments described above.

A vent housing is formed 610. Layers of coalescing filter media are stacked in the housing 620. A media spacer is inserted in the housing 630. A membrane is coupled to the housing 640. A cap is coupled to the housing 650.

The vent housing is generally formed 610 to have a first axial end and a second axial end, with an axial sidewall of the vent housing extending between the first and second axial ends. An airflow pathway extends from the first axial end towards the second axial end. The vent housing can be formed 610 consistently with approaches that will generally be understood in the art. In one embodiment, the vent housing is formed 610 through an injection molding process. In another embodiment, the vent housing is formed 610 through blow molding. The vent housing can be formed 610 from a variety of materials and combinations of materials. In one embodiment the vent housing is formed 610 from one or more of nylon, polyamide, glass-filled polyamide, polybutylene terephthalate, glass-filled polybutylene terephthalate, high-density polyethylene, and/or polypropylene.

The vent housing is formed with a support brace extending laterally across the airflow pathway. The support brace can be formed concurrently with the vent housing, or it can be formed separately and attached to the vent housing. The vent housing is also formed with a perimetric support surface, which partially extends perimetrically into the airflow pathway. The perimetric support surface is generally located towards the first axial end of the vent housing. The perimetric support surface may be formed concurrently with the vent housing, or it may be formed separately and attached to the vent housing. In some embodiments, the perimetric support surface and the support brace are formed as one contiguous component with the vent housing.

The support brace is generally attached to the axial sidewall of the vent housing by one or both of the two ends of the support brace. In embodiments, each end of the support brace is attached to the axial sidewall. In embodiments, one end of the support brace is attached to the axial sidewall. In embodiments wherein the support brace is attached to the axial sidewall after each has been separately formed, the end or ends of the support brace may be attached using adhesive, by melting the ends, using screws, or by any other suitable method known to the art.

The support brace generally has a lateral support surface facing the second axial end of the vent assembly. In embodiments, the lateral support surface is offset in the axial direction from the entire perimetric support surface. In certain embodiments, the lateral support surface is positioned axially between the perimetric support surface and the second axial end. In certain embodiments, the lateral support surface is positioned axially between the perimetric support surface and the first axial end.

In embodiments, the filter media is coalescing filter media. Coalescing filter media consistent with the descriptions herein may be suitable for use. When stacking a plurality of layers of coalescing filter media in the housing 620, the plurality of layers of coalescing filter media are generally stacked within the airflow pathway. Stacking the plurality of layers in the airflow pathway of the housing can be executed such that some of the layers of coalescing filter media are non-aligned with some of the other layers of coalescing filter media. Non-alignment of at least a portion of the plurality of layers of coalescing filter media can have the advantage of preventing air within the vent assembly from bypassing the coalescing filter media.

Generally, the stack is arranged in an axial direction. When the plurality of layers of coalescing filter media are stacked, the bottom-most layer is generally placed in contact with the lateral support surface and the perimetric support surface of the vent housing. The perimeter of the plurality of layers of filter media is generally placed in contact with the perimetric support surface. The plurality of layers of filter media may be inserted into one axial end of the vent housing and arranged to be in contact with the perimetric support surface and the lateral support surface. In embodiments wherein the lateral support surface is offset in the axial direction from the perimetric support surface, the plurality of layers of filter media may be non-planar.

Generally, the layers of filter media have a cross-dimension that is greater than the cross-dimension of the airflow pathway at the axial position of the sheet of filter media. Filter media having a cross-dimension that is greater than the cross-dimension of the airflow pathway may be advantageous for reasons described herein.

Any suitable number of layers of filter media may be used. In some embodiments, at least two, at least five, at least eight, at least 10, at least 20, at least 30, at least 50, or at least 100 sheets of filter media are stacked in the vent housing.

In some embodiments, the vent housing further comprises a splash guard. The splash guard is disposed across the airflow pathway and is spaced in the axial direction from the support brace. In embodiments, the splash guard and the support brace define a tortuous fluid pathway between the enclosure opening and the filter media. Materials suitable for the splash guard are consistent with those described herein.

In some embodiments, the method further comprises coupling a membrane to the vent housing between the filter media and the second axial end of the vent housing. The membrane is generally configured to prevent particulate from contacting the filter media. Membranes suitable for this purpose are described in greater detail herein.

In some embodiments, the method further comprises inserting a spacing region into the vent housing. The spacing region generally includes a media spacer. The media spacer may be positioned towards the second axial end of the vent housing, such as between the filter media and the membrane.

In some embodiments, the method further comprises coupling a cap to the vent housing. As described herein, a cap may advantageously prevent particulate from contacting the membrane or filter media of the vent assembly.

### Exemplary Aspects

Aspect 1. A vent assembly comprising:
a vent housing having: a first axial end, a second axial end, and an airflow pathway extending from the first axial end towards the second axial end, an environmental opening towards the second axial end configured for fluid communication with an external environment, an enclosure opening towards the first axial end configured for fluid communication with an interior of an enclosure,
a perimetric support surface surrounding the airflow pathway, and
a support brace extending across the airflow pathway, wherein the support brace has a lateral support surface offset in the axial direction from at least a portion of the perimetric support surface; and
filter media disposed laterally across the airflow pathway, wherein the filter media has a perimeter region supported by the perimetric support surface around the airflow pathway, and the filter media has a central region supported by the lateral support surface whereby the filter media is non-planar.

Aspect 2. The vent assembly of any one of aspects 1 or 4 to 13, wherein the lateral support surface is positioned axially between the perimetric support surface and the second axial end.

Aspect 3. The vent assembly of any one of aspects 1 or 4 to 13, wherein the lateral support surface is positioned axially between the perimetric support surface and the first axial end.

Aspect 4. The vent assembly of any one of aspects 1 to 3 or 5 to 13, wherein the lateral support surface is offset in the axial direction from the entire perimetric support surface.

Aspect 5. The vent assembly of any one of aspects 1 to 4 or 6 to 13, wherein the housing comprises an axial sidewall surrounding the airflow pathway, and the support brace has two ends that are each coupled to the axial sidewall.

Aspect 6. The vent assembly of any one of aspects 1 to 5 or 7 to 13, wherein the filter media is a sheet of filter media.

Aspect 7. The vent assembly of aspect 6, wherein the sheet of filter media has a cross-dimension that is greater than the cross-dimension of the airflow pathway at the axial position of the sheet of filter media.

Aspect 8. The vent assembly of any one of aspects 1 to 7 or 9 to 13, wherein the support brace is a cohesive component with the vent housing.

Aspect 9. The vent assembly of any one of aspects 1 to 8 or 10 to 13, further comprising a splash guard disposed across the airflow pathway, wherein the splash guard is spaced in the axial direction from the support brace and wherein the splash guard and the support brace define a tortuous fluid pathway between the enclosure opening and the filter media.

Aspect 10. The vent assembly of any one of aspects 1 to 9 or 11 to 13, further comprising a membrane coupled to the vent housing between the filter media and the second axial end.

Aspect 11. The vent assembly of aspect 10, further comprising a spacing region between the filter media and the membrane.

Aspect 12. The vent assembly of any one of aspects 1 to 11 or 13, wherein the filter media comprises coalescing filter media.

Aspect 13. The vent assembly of any one of aspects 1 to 12, wherein the filter media comprises at least 10 sheets of filter media arranged in a stack in the axial direction.

Aspect 14. A method of making a vent assembly, comprising:
forming vent housing comprising a first axial end and a second axial end, the vent housing defining an airflow pathway extending from the first axial end towards the second axial end, the vent housing comprising a perimetric support surface surrounding the airflow pathway and a support brace extending across the airflow pathway, the support brace having a lateral support surface offset in the axial direction from at least a portion of the perimetric support surface, and the vent housing comprising an environmental opening towards the second axial end; and
stacking a plurality of layers of filter media in the airflow pathway within the housing, wherein the filter media has a perimeter region supported by the perimetric support surface around the airflow pathway, and the filter media has a central region supported by the lateral support surface whereby the filter media is non-planar.

Aspect 15. The method of any one of aspects 14 or 17 to 26, wherein the lateral support surface is positioned axially between the perimetric support surface and the second axial end.

Aspect 16. The method of any one of aspects 14 or 17 to 26, wherein the lateral support surface is positioned axially between the perimetric support surface and the first axial end.

Aspect 17. The method of any one of aspects 14 to 16 or 18 to 25, wherein the lateral support surface is offset in the axial direction from the entire perimetric support surface.

Aspect 18. The method of any one of aspects 14 to 17 or 19 to 26, wherein the housing comprises an axial sidewall surrounding the airflow pathway, and the support brace has two ends that are each coupled to the axial sidewall.

Aspect 19. The method of any one of aspects 14 to 18 or 20 to 26, wherein the support brace is a cohesive component with the vent housing.

Aspect 20. The method of any one of aspects 14 to 19 or 21 to 26, wherein the plurality of layers of filter media has a cross-dimension that is greater than the cross-dimension of the airflow pathway at the axial position of the layer of filter media.

Aspect 21. The method of any one of aspects 14 to 20 or 22 to 26, wherein the vent assembly further comprises a splash guard disposed across the airflow pathway, wherein the splash guard is spaced in the axial direction from the support brace and wherein the splash guard and the support brace define a tortuous fluid pathway between the environmental opening and the filter media.

Aspect 22. The method of any one of aspects 14 to 21 or 23 to 26, further comprising coupling a membrane to the vent housing between the filter media and the second axial end.

Aspect 23. The method of any of aspects 14 to 22 or 24 to 26, further comprising inserting a media spacer between the filter media and the second axial end.

Aspect 24. The method of any one of aspects 14 to 23 or 25 to 26, wherein the filter media comprises coalescing filter media.

Aspect 25. The method of any one of aspects 14 to 24 or 26, wherein the stack of the plurality of layers of the filter media comprises at least 10 sheets of filter media arranged in a stack in the axial direction.

Aspect 26. The method of any one of aspects 14 to 25, further comprising coupling a cap to the vent housing.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

1. A vent assembly comprising:
a vent housing having:
a first axial end, a second axial end, and an airflow pathway extending from the first axial end towards the second axial end,
an environmental opening towards the second axial end configured for fluid communication with an external environment,
an enclosure opening towards the first axial end configured for fluid communication with an interior of an enclosure,
a perimetric support surface surrounding the airflow pathway, and
a support brace extending across the airflow pathway, wherein the support brace has a lateral support surface offset in the axial direction from at least a portion of the perimetric support surface; and
filter media disposed laterally across the airflow pathway, wherein the filter media has a perimeter region supported by the perimetric support surface around the airflow pathway, and the filter media has a central region supported by the lateral support surface whereby the filter media is non-planar.

2. The vent assembly of claim 1, wherein the lateral support surface is positioned axially between the perimetric support surface and the second axial end.

3. The vent assembly of claim 1, wherein the lateral support surface is positioned axially between the perimetric support surface and the first axial end.

4. The vent assembly of claim 1, wherein the lateral support surface is offset in the axial direction from the entire perimetric support surface.

5. The vent assembly of claim 1, wherein the housing comprises an axial sidewall surrounding the airflow pathway, and the support brace has two ends that are each coupled to the axial sidewall.

6. (canceled)

7. The vent assembly of claim 1, wherein filter media is a sheet of filter media having a cross-dimension that is greater than the cross-dimension of the airflow pathway at the axial position of the sheet of filter media.

8. (canceled)

9. The vent assembly of claim 1, further comprising a splash guard disposed across the airflow pathway, wherein the splash guard is spaced in the axial direction from the support brace and wherein the splash guard and the support brace define a tortuous fluid pathway between the enclosure opening and the filter media.

10. The vent assembly of claim 1, further comprising a membrane coupled to the vent housing between the filter media and the second axial end.

11. The vent assembly of claim 10, further comprising a spacing region between the filter media and the membrane.

12. The vent assembly of claim 1, wherein the filter media comprises coalescing filter media.

13. (canceled)

14. A method of making a vent assembly comprising:
forming vent housing comprising a first axial end and a second axial end, the vent housing defining an airflow pathway extending from the first axial end towards the second axial end, the vent housing comprising a perimetric support surface surrounding the airflow pathway and a support brace extending across the airflow pathway, the support brace having a lateral support surface offset in the axial direction from at least a portion of the perimetric support surface, and the vent housing comprising an environmental opening towards the second axial end; and
stacking a plurality of layers of filter media in the airflow pathway within the housing, wherein the filter media has a perimeter region supported by the perimetric support surface around the airflow pathway, and the filter media has a central region supported by the lateral support surface whereby the filter media is non-planar.

15. The method of claim 14, wherein the lateral support surface is positioned axially between the perimetric support surface and the second axial end.

16. The method of claim 14, wherein the lateral support surface is positioned axially between the perimetric support surface and the first axial end.

17. (canceled)

18. The method of claim 14, wherein the housing comprises an axial sidewall surrounding the airflow pathway, and the support brace has two ends that are each coupled to the axial sidewall.

19. The method of claim 14, wherein the support brace is a cohesive component with the vent housing.

20. (canceled)

21. The method of claim 14, wherein the vent assembly further comprises a splash guard disposed across the airflow pathway, wherein the splash guard is spaced in the axial direction from the support brace and wherein the splash guard and the support brace define a tortuous fluid pathway between the environmental opening and the filter media.

22. The method of claim 14, further comprising coupling a membrane to the vent housing between the filter media and the second axial end.

23. The method of claim 14, further comprising inserting a media spacer between the filter media and the second axial end.

24. (canceled)

25. The method of claim 14, wherein the stack of the plurality of layers of the filter media comprises at least 10 sheets of filter media arranged in a stack in the axial direction.

26. The method of claim 14, further comprising coupling a cap to the vent housing.
